(19) United States
(12) Patent Application Publication
(10) Pub. No.: US 2010/0151353 A1
(43) Pub. Date: Jun. 17, 2010

(54) Method of producing a gas-tight solid electrolyte layer and solid electrolyte layer

(75) Inventors: Rudolf Henne, Boeblingen (DE); Johannes Arnold, Pforzheim (DE)

Correspondence Address: Lipsitz & McAllister, LLC, 755 MAIN STREET, MONROE, CT, 06468, US

(73) Assignee: Deutsches Zentrum fuer Luft-und Raumfahrt e.V., Koeln (DE)

(21) Appl. No.: 12/590,455

(22) Filed: Nov. 6, 2009

Related U.S. Application Data
(63) Continuation of application No. PCT/EP2008/056020, filed on May 16, 2008.

(30) Foreign Application Priority Data
May 31, 2007 (DE) 10 2007 026 233

(51) Int. Cl. H01M 8/10; H01M 8/00

(52) U.S. Cl. 429/496; 429/495; 427/115

(57) ABSTRACT

Method of producing a gas-tight solid electrolyte layer for a high-temperature fuel cell, wherein a layer is produced from a metal oxide material and metal particles are incorporated in the layer during production of the layer, the metal particles being oxidizable, and wherein the metal particles are subsequently oxidized.

This application is a continuation of international application number PCT/EP2008/056020 filed on May 16, 2008.

The present disclosure relates to the subject matter disclosed in international application number PCT/EP2008/056020 of May 16, 2008 and German application number 10 2007 026 233.9 of May 31, 2007, which are incorporated herein by reference in their entirety and for all purposes.

### BACKGROUND OF THE INVENTION

The invention relates to a method of producing a gas-tight solid electrolyte layer.

The invention further relates to a solid electrolyte layer for a high-temperature fuel cell.

There is known from DE 10 2004 054 982 A1 a method of producing a gas-tight solid electrolyte layer comprising the steps of infiltrating an electrolyte layer which is unsintered or has been presintered at temperatures below 1150° C. and has been applied to a substrate with a fluid containing zirconium, and sintering the infiltrated electrolyte layer at a temperature below 1400° C.

There is known from DE 10 2005 045 053 A1 a method of producing an electrically insulating sealing arrangement for a fuel cell stack which comprises a plurality of fuel cell units that succeed one another along a stack direction, comprising the method steps of producing a ceramic metal layer from a mixture of a ceramic material and a metal material and/or a metal precursor, and at least partially converting the metal of the ceramic metal layer into an electrically non-conductive metal compound so as to produce a non-conductive boundary layer.

There is known from DE 103 02 122 A1 a method of producing a sealing structure for a fuel cell and/or an electrolyzer, wherein an insulating layer of the sealing structure is applied onto predetermined sealing areas of separator plates of a single fuel cell by a spraying process.

There is known from DE 11 2006 000 220 T5 a method of producing a cell for solid oxide fuel cells, wherein a porous electrolyte layer is formed in order to obtain an electrolyte substrate.

### SUMMARY OF THE INVENTION

In accordance with the present invention, a method is provided, with which a solid electrolyte layer with a high degree of gas-tightness can be produced in an easily performed manner.

In accordance with an embodiment of the invention, a layer is produced from a metal oxide material and metal particles are incorporated in the layer during production of the layer, the metal particles being oxidizable, and the metal particles are subsequently oxidized.

During production of the layer from metal oxide material, in particular, using powder particles, imperfections such as pores and microcracks may occur, which enable hydrogen diffusion between the anode and the cathode. The higher the degree of gas-tightness of the solid electrolyte layer, the higher is the open cell voltage (OCV) that is achievable. A high open cell voltage, in turn, means a high electrical efficiency of the high-temperature fuel cell.

In the solution according to the invention, metal particles are incorporated, which are later oxidized, i.e., after incorporation, (for example, during operation of the fuel cell). This results in a redensification of the solid electrolyte layer, which reduces its gas permeability. The hydrogen diffusion between anode and cathode can thereby be sufficiently eliminated.

Furthermore, as a rule, oxidized particles have a larger volume than corresponding metal particles from which they are formed, so that imperfections such as pores and microcracks can thereby be closed in an effective manner.

With suitable metal particles, it is also possible for the conductivity for oxygen ions in the solid electrolyte layer to be increased by these. Metal particles can flatten upon impact with a substrate and form “splats”, which may result in a bridge formation with the aforementioned increased conductivity for oxygen ions.

Suitable choice of the material of the metal particles makes it possible for incorporation of the metal particles not to negatively affect the functionality of the high-temperature fuel cell.

The solution according to the invention makes it possible to produce thin solid electrolyte layers with a high degree of gas-tightness. Owing to the possibility of thin manufacture with low material usage (and therefore reduced manufacturing time) a high electrochemical efficiency is obtained as the electrical resistance of the high-temperature fuel cell can be kept low. (In principle, the electrical resistance is all the higher, the greater the layer thickness of the solid electrolyte layer. The higher the electrical resistance, the lower is the efficiency of the high-temperature fuel cell.)

A thin solid electrolyte layer, for example, in the order of magnitude of a few 10 μm can be produced by the method according to the invention, with there being no necessity for an additional sintering step.

In particular, the solid electrolyte layer is conductive for oxygen ions. It is thus possible to separate the cathode and anode in a gas-tight manner from each other by means of the solid electrolyte layer, and to electrically separate them from each other with respect to electron conduction, with oxygen ion diffusion through the solid electrolyte layer being possible for closure of the electric circuit.

For the aforementioned reasons, it is advantageous for the solid electrolyte layer to be an insulating layer for electron conduction.

The metal particles are expediently selected so as to be oxidizable in an exothermic reaction. Oxidation for closure of pores, microcracks and the like in a solid electrolyte layer is thereby possible in an effective manner.

For example, the oxidation of the metal particles takes place by way of operation of the high-temperature fuel cell. During operation of the high-temperature fuel cell, oxygen ions diffuse through the solid electrolyte layer. These oxygen ions can result in an oxidation of the incorporated metal particles. These reactions are irreversible, and a redensification of the solid electrolyte layer is thereby brought about, with its gas permeability being reduced. There is then no necessity for special steps for oxidizing the metal particles in the solid electrolyte layer. After operation of the high-temperature fuel cell over a certain period of time, the solid electrolyte layer no longer exhibits any incorporated metal particles. These have been converted into electrically non-conductive metal oxides, and pores and cracks and the like have thereby been closed.

It has proven expedient for the metal particles to be made of a metal of the third or fourth subgroup. Such metal particles can, for example, during the plasma spraying flatten upon impact with a substrate and form so-called “splats”. This results in a bridge formation, the consequence of which is an increased conductivity for oxygen ions.

For example, the metal particles are made of Sc, Y, La, Ti, Zr or Hf. Metal particles from various metals may be used simultaneously.

In one embodiment, the metal particles are made of the same material as the chemical element in the metal oxide material for production of the layer. It is, however, also possible for the metal particles to be made of a different material than the chemical element in the metal oxide material.

Use of a metal precursor has proven expedient for incorporating the metal particles. A metal precursor which is more inert than the corresponding metal can be used. It can thereby be guaranteed that metal particles are actually incorporated in the layer, with the metal particles comprising the metallic material and not a metal oxide material produced “in flight” during the manufacture. The metal precursor is suitable if it disintegrates prior to application to the substrate.

For example, metal hydride is used as metal precursor. Metal particles can be incorporated in the layer by reduction of the hydride and formation of the metal. As a rule, metal can thus be incorporated in a spray coating in a more cost-effective and reliable manner than when, for example, metal particles are sprayed directly. For example, zirconium powder and titanium powder have a high ignitability, so that these materials are difficult to handle in contrast to corresponding hydride powders.

In particular, the weight proportion of the metal particles ranges from 1% to 10% in relation to the remaining material of the solid electrolyte layer. Therefore, the proportion of the metal particles in weight percent is at most 1% to 10% of the total weight of the manufactured solid electrolyte layer.

It is expedient for the metal particles to be incorporated with a defined distribution. This can be achieved by corresponding performance of the method. For example, metal particles are incorporated in a homogeneously distributed manner. As a result, closure of pores, microcracks and the like can be achieved uniformly over the entire volume of the solid electrolyte layer by oxidation of the metal particles, and, in turn, a gas-tightness with a high degree of tightness can be achieved. A graduated distribution may also be provided. As a result, a higher concentration of metal particles can, for example, be set in areas in which a solder connection is to be made.

It has proven expedient for the solid electrolyte layer to be produced by thermal spraying. Owing to the short interaction time between spray material and thermal jet achievable in thermal spraying, for example, flame spraying or plasma spraying, thermal loads on the spray material and the substrate are relatively low. The corresponding solid electrolyte layer can be produced within a short time (in the order of magnitude of a few minutes depending on the surface to be coated). During the thermal spraying, spray material is blown in powder form into a jet, accelerated there and melted. The solidifying droplets become superimposed on the substrate, and a closed layer, and, in particular, ceramic layer, is formed, without a subsequent sintering being required.

In particular, metal particles and/or metal precursor particles and particles of metal oxide material are sprayed onto a substrate. The metal particles and/or metal precursor particles are blown into a thermal jet, i.e., a jet with a temperature above the melting temperature of the material to be applied. With a corresponding blow-in setting, a homogenous distribution of metal particles can thereby be achieved in the manufactured solid electrolyte layer. Furthermore, a defined concentration of metal particles can be set by corresponding setting of the blow-in parameters and, in particular, the material throughput. If required, a defined graduation of the distribution of the metal particles can also be set.

It is provided that the parameters are set such that and/or the metal precursor particles are selected such that metal particles are formed from the metal precursor particles in flight. If, for example, metal precursor particles of metal hydride are used, then these are to disintegrate in flight, resulting in formation of the metal, i.e., the hydride is reduced and the metallic material is formed.

It has proven expedient for the solid electrolyte layer to be produced by plasma spraying. The corresponding starting materials are blown into a plasma jet, accelerated there and melted. A dense solid electrolyte layer can thereby be formed without any additional sintering process step. In principle, there is the possibility of imperfections being formed by unmolten or only partially molten particles. With the solution according to the invention, with the incorporation of metal particles in the solid electrolyte layer, which can later oxidize, such imperfections can be “eliminated” without any laborious subsequent treatment.

In particular, the solid electrolyte layer is produced by vacuum plasma spraying. It is thereby possible to prevent metal oxides from being formed as a result of the reaction of the metal with atmospheric oxygen when applying metal particles or metal precursor particles. This guarantees that metal particles (and not metal oxides) are incorporated in the solid electrolyte layer for the subsequent oxidation.

In one embodiment, the solid electrolyte layer is zirconia. This may be, for example, yttrium-stabilized.

It is then expedient for zirconium hydride to be used for formation of the metal particles.

In particular, the solid electrolyte layer is a ceramic layer. This ceramic layer is produced, in particular, by thermal spraying, without a subsequent sintering step being performed.

In accordance with the invention, a solid electrolyte layer for a high-temperature fuel cell is provided, which is produced in accordance with the method according to the invention. This solid electrolyte layer has two defined states. After manufacture, there are incorporated in it metal particles which are oxidizable.

After the oxidation, which is performed, for example, by way of operation of the high-temperature fuel cell, there are essentially no more metal particles present; these are oxidized. The microstructure has thereby undergone change. Pores, microcracks and the like have been closed by the metal oxide formation. A redensification has taken place, which has led to a reduced gas permeability.

The following description of preferred embodiments serves in conjunction with the drawings to explain the invention in greater detail.

### BRIEF DESCRIPTION OF THE DRAWINGS

FIG. 1 shows a schematic partially sectional representation of an embodiment of a high-temperature fuel cell; and

FIG. 2 shows a schematic representation of an apparatus for the manufacture of a gas-tight solid electrolyte layer.

### DETAILED DESCRIPTION OF THE INVENTION

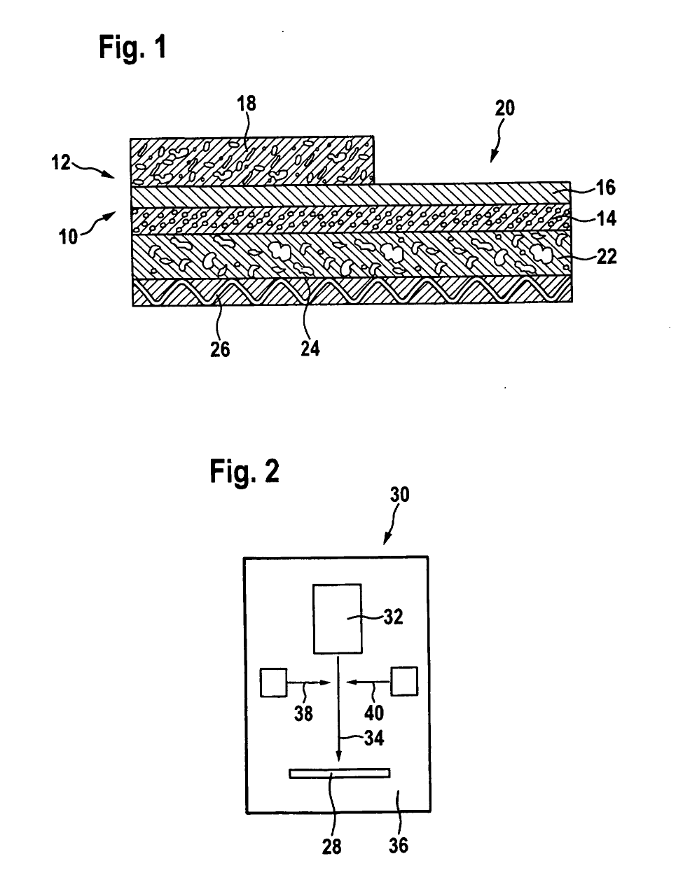

One embodiment of a high-temperature fuel cell is an oxide-ceramic fuel cell (SOFC—solid oxide fuel cell). A high-temperature fuel cell module, which is shown schematically in a partially sectional representation in FIG. 1 and designated therein by 10, comprises an electrochemical functional device 12 with an anode 14, a solid electrolyte 16 and a cathode 18. The anode 14, the solid electrolyte 16 and the cathode 18 form an anode-electrolyte-cathode unit 20.

The anode 14 is arranged on an anode carrier 22. The anode carrier 22 is electrically conductive (electron conducting) and made of a porous material, so that the gaseous fuel can pass through the anode carrier 22 to the anode 14. The anode carrier 22 is a mechanical carrier for the anode 14, through which an electrical contacting of the anode 14 with, for example, a housing (not shown in the drawing) is enabled.

An electrical contact device 26 can be arranged on the anode carrier 22 at a side 24 located opposite the side on which the anode 14 is arranged. This is made, in particular, of a metallic material. The electrical contact device 26 is in mechanical and electrical contact with a housing. It thereby ensures electrical contacting of the anode 14 with the housing. The electrical contact device 26 is, for example, soldered or welded to the anode carrier 22 and the housing. The anode carrier and, therefore, the electric functional device 12 are supported by means of the electrical contact device 26 on the housing.

The electrical contact device 26 is of gas-permeable construction, so that fuel gas can pass to the anode 14. The electrical contact device 26 is configured as, for example, net or woven or knitted fabric.

The anode is, for example, partly made of an oxide-ceramic material and comprises an anodic catalyst. For example, the anode 14 is made of nickel zirconia.

The anode 14 is produced as a layer having a thickness in the order of magnitude of a few 10 μm.

The solid electrolyte 16 is formed on the anode 14 and, in particular, is produced as a layer. A typical layer thickness of the solid electrolyte lies in the order of magnitude of a few 10 μm. As the layer thickness increases, the electrical resistance increases and, therefore, the electrical efficiency of the high-temperature fuel cell decreases.

The solid electrolyte 16 is gas-tight. It forms an insulator for electron conduction and is oxygen ion conductive.

In one embodiment, the solid electrolyte 16 is made of yttrium-stabilized zirconia. Further examples of materials are scandium oxide-doped zirconia or gadolinium-doped cerium oxide. The cathode 18 is arranged on the solid electrolyte 16. It is made, for example, of an oxide-ceramic material. Mixed oxides such as lanthanum-strontium-manganate are, for example, used for the manufacture. In particular, the cathode 18 is formed as a layer having a layer thickness in the order of magnitude of a few 10 μm.

The following partial reaction:

$$\frac{1}{2} {O}_{2} + 2 {e}^{-} {O}^{2 -}$$

takes place at the cathode 18 in a high-temperature fuel cell 10.

Fuel is supplied to the anode 14. The following partial reaction takes place:

H₂+O²⁻→H₂O+2e⁻.

The corresponding high-temperature fuel cell 10 is operated at a temperature ranging from approximately 650° C. to 1000° C.

The fuel, which is or contains hydrogen gas, may, for example, be supplied through a reformer.

The solid electrolyte 16 is produced as follows:

The solid electrolyte 16 is produced as a coating on a substrate which is formed by the anode 14 on the anode carrier 22. The layer is produced by metal oxide particles (powder particles) being applied by thermal spraying. The particles are melted during the thermal spraying, and the solid electrolyte layer 16 is produced as a ceramic layer.

In accordance with the invention, metal particles are incorporated in the layer by the metal oxide particles during the formation of the solid electrolyte layer 16. These metal particles serve to avoid imperfections/vacancies due to unmolten or only partially molten metal oxide particles by these imperfections/vacancies being “closed”. The metal particles are selected so as to be oxidizable (to form a metal oxide material), in particular, in an exothermic reaction.

Examples of metal materials for the metal particles are metals of the third and fourth subgroups such as Sc, Y, La, Ti, Zr and Hf. It is possible for metallic materials which produce a metal oxide from which the solid electrolyte 16 is formed to be used for the metal particles. For example, yttrium and/or zirconium is used as material for the metal particles for a solid electrolyte made of yttrium-stabilized zirconia. It is also possible to use metal materials which under oxidation form metal oxides which are different from the metal oxide or oxides of which the remaining solid electrolyte 16 is made up.

Metal particles (also those made of metals of the third and fourth subgroups) have the advantageous characteristic that they flatten and form so-called “splats” upon impact with a substrate for formation of the layer. This results in a bridge formation, the consequence of which is an increased conductivity for oxygen ions in the manufactured solid electrolyte 16.

In general, the material for the metal particles is selected such that in the manufactured high-temperature fuel cell there are no negative effects on its functionality and, in particular, ion conductivity and electrical conductivity.

The oxidation of the metal particles incorporated in a manufactured solid electrolyte 16 takes place, for example, by way of operation of the manufactured high-temperature fuel cell 10. In operation, oxygen ions which cause the oxidation of the metal particles diffuse through the solid electrolyte 16. A redensification of the solid electrolyte layer is thereby obtained. This is further intensified by oxidized metal particles generally assuming a larger volume than metal particles made of the pure metal.

In an embodiment shown schematically in FIG. 2, the solid electrolyte 16 is produced on a substrate 28 by plasma spraying using a plasma spray device 30. A plasma torch 32 produces a plasma jet 34. For example, a vacuum plasma spraying process (VPS) is carried out, in which the pressure is reduced.

Accordingly, the substrate 28 is arranged in a space 36 at subatmospheric pressure.

Powder particles of different grain size of the metal oxide material, which is the main material for the solid electrolyte 16, are blown into the plasma jet 34. This is indicated by reference numeral 38 in FIG. 2. The powder particles are accelerated by the plasma jet 34 and melted. The molten droplets solidify on the substrate 28; in the ideal case, the droplets solidify in the shape of pancakes. A closed layer, which forms the solid electrolyte 16, is thereby formed. Powder particles that have not or not fully melted are incorporated in the solid electrolyte layer 16 and may result in pores and microcracks. Pores and microcracks may also result from uneven or too quick solidification of the layer. Boundary layers or gaps which, in principle, may negatively affect the solidity and the ion conductivity may also be present between splats. Furthermore, they impair the gas-tightness. By virtue of the solution according to the invention, the gaps are closed by bridge formation, which also results in an increase in the ion conductivity.

Thin layers can be produced by thermal spraying processes and, in particular, by plasma spraying.

The metal particles or metal precursor particles are blown into the plasma jet 34 together with the metal oxide particles. The blowing-in of the metal particles or metal precursor particles is indicated by the arrow with reference numeral 40 in FIG. 2.

For example, particles made of metal hydride are used as metal precursor particles. Metal hydrides are more inert in the plasma jet 34 than metals. They have a relatively low decomposition temperature, which is exceeded in the plasma jet 34. This results in the reduction of the metal hydride and in the formation of the metal, i.e., metal particles are produced from the metal precursor particles. These are then incorporated in metal form in the resulting layer on the substrate 28. The likelihood of the metal reacting with atmospheric oxygen is minimized by the performance under reduced pressure, and, therefore, metal particles made of pure metal can be incorporated.

In a concrete embodiment, zirconium hydride in particle form is blown in together with zirconia particles. (In principle, it is also possible for, for example, zirconium metal particles to be sprayed directly; however, owing to the high ignitability of zirconium powder, this metal particle spraying is more dangerous and more expensive than use of zirconium hydride.)

The weight proportion of the metal particles in the manufactured solid electrolyte 16 prior to oxidation of the metal particles lies, for example, in the order of magnitude of between 1% and 10%. During the spraying care is taken to ensure that the metal particles are distributed in a defined manner in the manufactured solid electrolyte layer 16. For example, a homogeneous distribution is set. Accumulation areas may also be produced, for example, at solder areas. The setting of a graduated distribution is possible.

The solid electrolyte 16 can be produced as a ceramic layer in which pores, microcracks, gaps and the like are closed by oxidation of the metal particles. A redensification of the solid electrolyte 16 is thereby obtained, and its gas impermeability is increased. Hydrogen diffusion between the anode 14 and the cathode 18 can thereby be sufficiently eliminated. In turn, it is thus possible to manufacture the solid electrolyte 16 relatively thin, whereby a higher efficiency level of the high-temperature fuel cell 10 is obtained.

No additional sintering step is necessary for the solid electrolyte 16 in the manufacture of the high-temperature fuel cell 10. Imperfections in the solid electrolyte 16 can be reduced or even entirely eliminated by the method according to the invention.

The thermal load on the substrate 28 during the manufacture of the electrolyte 16 is relatively low. Owing to the relatively short interaction time (of a few milliseconds) between spray material and plasma in the plasma jet 34, thermal loads on the spray material and also on the substrate 28 when the plasma jet is moved at a corresponding speed over the substrate 28 are low.

Furthermore, owing to the plasma spraying it is possible to use coarse electrolyte material with particles having a particle size of a few 10 μm and, at the same time, fine hydride particles having a diameter of less than 10 μm. In particular, hydride particles having a size of between 1 μm and 50 μm are sprayed. A particle size of about 5 μm has proven advantageous for the hydride particles.

1. Method of producing a gas-tight solid electrolyte layer for a high-temperature fuel cell, comprising:
producing a layer from a metal oxide material; and
incorporating metal particles in the layer during production of the layer, wherein the metal particles are oxidizable; and
subsequently oxidizing the metal particles.

2. Method in accordance with claim 1, wherein the solid electrolyte layer is conductive for oxygen ions.

3. Method in accordance with claim 1, wherein the solid electrolyte layer is an insulating layer for electron conduction.

4. Method in accordance with claim 1, wherein the metal particles are oxidizable in an exothermic reaction.

5. Method in accordance with claim 1, wherein the oxidation of the metal particles takes place by way of operation of the high-temperature fuel cell.

6. Method in accordance with claim 1, wherein the metal particles are made of a metal of the third or fourth subgroups.

7. Method in accordance with claim 1, wherein the metal particles are made of Sc, Y, La, Ti, Zr or Hf.

8. Method in accordance with claim 1, wherein the metal particles are made of the same material as the metal in the metal oxide material.

9. Method in accordance with claim 1, wherein a metal precursor is used to incorporate the metal particles.

10. Method in accordance with claim 9, wherein metal hydride is used as metal precursor.

11. Method in accordance with claim 1, wherein the weight proportion of the metal particles ranges from 1% to 10% in relation to the remaining material of the solid electrolyte layer.

12. Method in accordance with claim 1, wherein the metal particles are incorporated with a defined distribution.

13. Method in accordance with claim 1, wherein the solid electrolyte layer is produced by thermal spraying.

14. Method in accordance with claim 13, wherein particles of metal oxide material and at least one of metal particles and metal precursor particles are spayed onto a substrate.

15. Method in accordance with claim 13, comprising at least one of the steps setting the parameters such that and selecting the metal precursor particles such that metal particles are formed from the metal precursor particles in flight.

16. Method in accordance with claim 13, wherein the solid electrolyte layer is produced by plasma spraying.

17. Method in accordance with claim 16, wherein the solid electrolyte layer is produced by vacuum plasma spraying.

18. Method in accordance with claim 1, wherein the solid electrolyte layer comprises zirconia.

19. Method in accordance with claim 18, wherein zirconium hydride is used to form the metal particles.

20. Method in accordance with claim 1, wherein the solid electrolyte layer is a ceramic layer.

21. Solid electrolyte layer for a high-temperature fuel cell, which is produced by a method comprising:
producing a layer from a metal oxide material;
incorporating oxidizable metal particles in the layer during production of the layer; and
subsequently oxidizing the metal particles.
